(19) United States
(12) Patent Application Publication
(10) Pub. No.: US 2024/0416768 A1
(43) Pub. Date: Dec. 19, 2024

(54) POWER TRANSFER USING MULTI-WINDING ELECTRIC MACHINES

(71) Applicant: GM Global Technology Operations LLC, Detroit, MI (US)

(72) Inventors: Peng Peng, Columbus, OH (US); Lei Hao, Troy, MI (US); Suresh Gopalakrishnan, Troy, MI (US)

(21) Appl. No.: 18/334,634

(22) Filed: Jun. 14, 2023

(51) Int. Cl. B60L 53/14; B60L 50/51; B60L 53/24

(52) U.S. Cl. CPC B60L 53/14; B60L 50/51; B60L 53/24; B60L 2210/30; B60L 2210/40

(57) ABSTRACT

An energy transfer system of a vehicle includes a multi-winding motor, a first inverter connected to a first set of windings, and a second inverter connected to a second set of windings. The system includes a controller configured to control the first inverter and the second inverter to control a charging current through the multi-winding motor at a desired power when the multi-winding motor is in a zero-torque condition. The controller is configured to control the charging current through the first inverter and second inverter so that a first current vector associated with the first set of windings and a second vector associated with the second set of windings are symmetric about a d-axis and the multi-winding motor functions as a transformer, the control of the first inverter and the second inverter providing for power transfer between the first set of windings and the second set of windings.

### INTRODUCTION

The subject disclosure relates to power transfer to and/or from an energy storage system such as a vehicle battery system, and more specifically, to controlling the transfer of power or energy using a multi-winding electric machine.

Vehicles, including gasoline and diesel power vehicles, as well as electric and hybrid electric vehicles, feature battery storage for purposes such as powering electric motors, electronics and other vehicle subsystems. Electric and hybrid vehicles (e.g., automobiles, trucks, construction equipment, automated factory equipment, farm equipment, etc.) are charged with external power sources (e.g., charging stations, electrical grid, etc.). Charging may include alternating current (AC) charging (e.g., level 1 or level 2 outlet connected to the grid) or a direct current (DC) charging (e.g., DC fast charging (DCFC)). Additionally, the flow of current may be reversed to allow a vehicle to power an external energy storage system (e.g., the grid, another vehicle, etc.). Typically, charging is handled by a vehicle charger, such as an on-board charging module (OBCM) that includes conversion devices for performing functions such as voltage control and AC-DC power conversion.

### SUMMARY

In one exemplary embodiment, an energy transfer system of a vehicle includes a multi-winding motor including a first set of windings and a second set of windings, the multi-winding motor connected to a battery system, a first inverter connected to the first set of windings, and a second inverter connected to the second set of windings. The system also includes a controller configured to receive a request for transfer of energy, put the multi-winding motor into a charging mode, and control the first inverter and the second inverter to control a charging current through the multi-winding motor at a desired power when the multi-winding motor is in a zero-torque condition, where the controller is configured to control the charging current through the first inverter and second inverter so that a first current vector associated with the first set of windings and a second vector associated with the second set of windings are symmetric about a d-axis and the multi-winding motor functions as a transformer. The control of the first inverter and the second inverter provides for power transfer between the first set of windings and the second set of windings.

In addition to one or more of the features described herein, the controller is configured to control the charging current based on a reference charging current value derived from a calibration of an optimal value of a d-axis current and an optimal value of a q-axis current, the optimal values determined based on a power transfer capability of the multi-winding motor.

In addition to one or more of the features described herein, the reference charging current value is a minimum magnitude of the charging current that can be applied to achieve a desired charging power.

In addition to one or more of the features described herein, the power transfer capability is estimated based on an energy relation indicative of an energy E as a function of the d-axis current and the q-axis current.

In addition to one or more of the features described herein, the power transfer capability is used to determine a maximum power per ampere (MPPA) for a given motor speed.

In addition to one or more of the features described herein, the MPPA prescribes a minimum charging current for a given motor speed, the minimum charging current determined based on the optimal value of the d-axis current and the optimal value of the q-axis current.

In addition to one or more of the features described herein, the system further includes a switch configured to selectively connect the first inverter to the battery system, the switch configured to be closed when the vehicle is in a propulsion mode.

In addition to one or more of the features described herein, the charging current is an AC current, the switch is configured to be open to put the multi-winding motor into the charging mode, and the controlling of the first inverter and the second inverter includes operating the first set of windings and the second set of windings as an isolated transformer to transfer power between the first set of windings and the second set of windings.

In another exemplary embodiment, a method of transferring energy to or from a battery system of a vehicle includes receiving a request for transfer of energy at a controller connected to a charging system of the vehicle, the charging system including a multi-winding motor including a first set of windings and a second set of windings, a first inverter connected to the first set of windings, and a second inverter connected to the second set of windings, wherein the multi-winding motor is connected to the battery system. The method also includes putting the multi-winding motor into a charging mode, and controlling the first inverter and the second inverter to control a charging current through the multi-winding motor at a desired power when the multi-winding motor is in a zero-torque condition, where the charging current is controlled through the first inverter and second inverter so that a first current vector associated with the first set of windings and a second vector associated with the second set of windings are symmetric about a d-axis and the multi-winding motor functions as a transformer. The controlling of the first inverter and the second inverter provides for power transfer between the first set of windings and the second set of windings.

In addition to one or more of the features described herein, the control of the charging current is based on a reference charging current value derived from a calibration of an optimal value of a d-axis current and an optimal value of a q-axis current, the optimal values determined based on a power transfer capability of the multi-winding motor.

In addition to one or more of the features described herein, the reference charging current value is a minimum magnitude of the charging current that can be applied to achieve a desired charging power.

In addition to one or more of the features described herein, the power transfer capability is estimated based on an energy relation indicative of an energy E as a function of the d-axis current and the q-axis current.

In addition to one or more of the features described herein, the energy relation is derived by at least one of simulation and experimentation.

In addition to one or more of the features described herein, the power transfer capability is used to determine a maximum power per ampere (MPPA) for a given motor speed, the MPPA prescribing a minimum charging current for a given motor speed, the minimum charging current determined based on the optimal value of the d-axis current and the optimal value of a q-axis current.

In addition to one or more of the features described herein, the charging system includes a switch configured to selectively connect the first inverter to the battery system, the switch configured to be closed when the vehicle is in a propulsion mode.

The method of claim 16, wherein the charging current is an AC current, and putting the multi-winding motor into the charging mode includes opening the switch, and controlling the first inverter and the second inverter includes operating the first set of windings and the second set of windings as an isolated transformer to transfer power therebetween.

In yet another exemplary embodiment, a vehicle system includes a memory having computer readable instructions, and a processing device for executing the computer readable instructions, the computer readable instructions controlling the processing device to perform a method. The method includes receiving a request for transfer of energy at a controller connected to a charging system of the vehicle, the charging system including a multi-winding motor including a first set of windings and a second set of windings, a first inverter connected to the first set of windings, and a second inverter connected to the second set of windings, the multi-winding motor connected to the battery system. The method also includes putting the multi-winding motor into a charging mode, and controlling the first inverter and the second inverter to control a charging current through the multi-winding motor at a desired power when the multi-winding motor is in a zero-torque condition, where the charging current is controlled through the first inverter and second inverter so that a first current vector associated with the first set of windings and a second vector associated with the second set of windings are symmetric about a d-axis and the multi-winding motor functions as a transformer. The controlling of the first inverter and the second inverter provides for power transfer between the first set of windings and the second set of windings.

In addition to one or more of the features described herein, the control of the charging current is based on a reference charging current value derived from a calibration of an optimal value of a d-axis current and an optimal value of a q-axis current, the optimal values determined based on a power transfer capability of the multi-winding motor, wherein the reference charging current value is a minimum magnitude of the charging current that can be applied to achieve a desired charging power.

In addition to one or more of the features described herein, the power transfer capability is estimated based on an energy relation indicative of an energy E as a function of the d-axis current and q-axis current.

In addition to one or more of the features described herein, the power transfer capability is used to determine a maximum power per ampere (MPPA) for a given motor speed, the MPPA prescribing a minimum charging current for a given motor speed, the minimum charging current determined based on the optimal value of the d-axis current and the optimal value of the q-axis current.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a battery assembly or system and a multi-drive system, in accordance with an exemplary embodiment;

FIG. 2 depicts a charging system that includes components of a vehicle propulsion system having a dual winding electric machine, in accordance with an exemplary embodiment;

FIG. 3 depicts a portion of a dual or multi-winding electric machine, and represents properties of current vectors, in accordance with an exemplary embodiment;

FIG. 4 is a flow diagram depicting aspects of a method of controlling a vehicle charging system and/or charging an energy storage system, in accordance with an exemplary embodiment;

FIGS. 5A and 5B depicts contour plots illustrating aspects of an example of the method of FIG. 4, which includes estimating optimal d-axis and q-axis currents used to apply a charging current to a vehicle battery system; and

FIG. 6 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with exemplary embodiments, methods, devices and systems are provided for supplying electrical power from a battery system of a vehicle (e.g., an electric or hybrid vehicle) to an energy storage system, such as a battery of another vehicle. Embodiments may also be used to receive electrical power from a power source (e.g., a charging station) to provide charge to the battery system.

Embodiments of a charging system utilize a dual winding electric machine, such as a segmented winding electric motor/generator. The electric machine, in an embodiment, is part of a propulsion system of a vehicle (e.g., an electric or hybrid vehicle). For example, the electric machine is a three-phase (or poly-phase) motor having two sets of three-phase (or poly-phase) windings. The sets of windings are electrically isolated from each other, and each set of windings is connected to a respective inverter. For vehicle propulsion, one or both inverters are operated to provide alternating current (AC) to each phase of one or both sets of windings.

The charging system and the propulsion system can be put into various charging modes, for charging the vehicle battery system or providing charge to an external energy storage system (e.g., another vehicle or an electrical grid). An embodiment of a charging method includes determining a desired or optimal combination of q-axis and d-axis currents based on a model of the electric machine and a power transfer index. The power transfer index is calculated based on active power parameters of the electric machine, and corresponds to an energy of the machine independent of machine speed. The energy is a function of d-axis and q-axis currents. The optimal d-axis and q-axis currents are calibrated, in an embodiment, by determining a maximum power per ampere (MPPA), and a charging current is applied to a set of windings based on the optimal d-axis and q-axis currents.

Embodiments described herein present numerous advantages and technical effects. The embodiments provide for effective charging and discharging capability by operating a dual winding machine in an optimal manner that increases efficiency. Such increases are realized, for example, by minimizing or reducing the magnitude of current needed to affect desired charging parameters (e.g., charging power). In addition, the embodiments are applicable to a wide variety of charging and discharging operations.

In addition, the embodiments may utilize already existing components, and can simplify vehicle systems, thereby reducing the number of components and complexity of such systems. For example, the embodiments can eliminate the need for components such as an on-board charging module (OBCM) and a vehicle-to-load module, and allow for reducing the size of devices used to heat vehicle battery systems. The OBCM can be eliminated as the charging efficiency using the embodiments has been found to be at least as high as the charging efficiency of existing OBCMs.

The embodiments are not limited to use with any specific vehicle and may be applicable to various contexts. For example, embodiments may be used with automobiles, trucks, aircraft, construction equipment, farm equipment, automated factory equipment and/or any other device or system that includes multiple drives and/or multiple conversion devices.

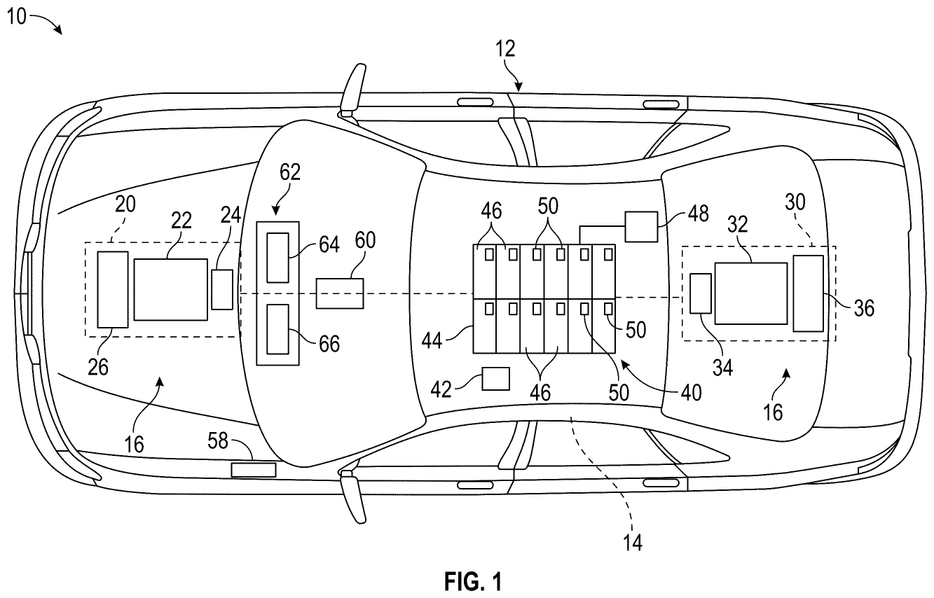

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be an electrically powered vehicle (EV), a hybrid vehicle or any other vehicle that features multiple electric motors or drive systems. In an embodiment, the vehicle 10 is an electric vehicle that includes multiple motors and/or drive systems. For example, the propulsion system 16 is a multi-drive system that includes a first drive system 20 and a second drive system 30. The first drive system 20 includes a first electric motor 22 and a first inverter module 24, as well as other components such as a cooling system 26. The second drive system 30 includes a second electric motor 32 and a second inverter 34 module, and other components such as a cooling system 36. The inverter modules 24 and 34 (e.g., traction power inverter units or TPIMs) each convert direct current (DC) power from a high voltage (HV) battery pack 44 to poly-phase (e.g., two-phase, three-phase, six-phase, etc.) alternating current (AC) power to drive the motors 22 and 32.

As shown in FIG. 1, the drive systems are configured such that the first electric motor 22 drives front wheels (not shown) and the second electric motor 32 drives rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In an embodiment, the motor 20 and/or the motor 30 is/are multi-winding or dual winding electric machine(s). For example, the motor 20 and the motor 30 are segmented winding machines having at least two sets of electrically isolated windings. Each inverter module 24 and 34 includes at least two inverter circuits (inverters), such that each inverter can control current through a respective set of windings.

The drive system 20 and the drive system 30 are electrically connected to a battery system 40, and may also be electrically connected to other components, such as vehicle electronics (e.g., via an auxiliary power module or APM 42). The battery system 40 may be configured as a rechargeable energy storage system (RESS).

In an embodiment, the battery system 40 includes a battery assembly such as the battery pack 44. The battery pack 44 includes a plurality of battery modules 46, where each battery module 46 includes a number of individual cells (not shown). The battery system 40 may also include a monitoring unit 48 configured to receive measurements from sensors 50. Each sensor 50 may be an assembly or system having one or more sensors for measuring various battery and environmental parameters, such as temperature, current and voltages.

The vehicle 10 may include a charging system that can be used to charge the battery pack 44 and/or used for supplying power from the battery pack 44 to charge another energy storage system (e.g., V2V charging). The charging system includes at least one dual inverter and associated multi-winding electric machine that can be selectively connected to a charge port 58. For example, the motor 20 and/or the motor 30 are multi-winding electric machines, such as segmented winding machines, and the inverter 24 and/or the inverter 34 are configured as dual inverter or multi-inverter modules.

The charge port 58 includes or is connected to a bi-directional charger that permits bi-directional transfer of energy. The charging system can be used to transfer power from the battery pack 44 to charge an external energy storage system (e.g., another vehicle, a portable energy storage system, a grid, etc.). For example, the charging system is configured for vehicle-to-vehicle (V2V), vehicle-to-grid (V2G) and/or vehicle-to-everything (V2X) charging.

The charging system can be used to transfer power from an external energy storage system (e.g., a charging station, grid, a donor vehicle battery system) to charge the battery pack 44). For example, the charging system is configured for legacy or conventional charging, DC fast charging (DCFC), V2V charging, grid-to-vehicle (G2V) charging and/or load-to-vehicle (L2V) charging. Such power transfers may be referred to as discharging operations or processes.

Any of various controllers can be used to control functions of the charging system and/or other vehicle systems. A controller includes any suitable processing device or unit, and may use an existing controller such as a battery system controller (e.g., a RESS or battery management system controller), and/or controllers in the drive systems. For example, a controller 60 may be included for controlling charging operations as discussed herein.

The vehicle 10 also includes a computer system 62 that includes one or more processing devices 64 and a user interface 66. The computer system 62 may communicate with the charging system controller, for example, to provide commands thereto in response to a user input. The various processing devices, modules and units may communicate with one another via a communication device or system, such as a controller area network (CAN) or transmission control protocol (TCP) bus.\

Any of the switches described herein may be any suitable type of switch, such as a mechanical contactor, electronic switch or solid state switching device. Any suitable solid state or electronic device may be employed as a switch. For example, switches can include solid state relays or transistors such as Silicon (Si) insulated gate bipolar transistors (IGBTs), and field-effect transistors (FETs). Examples of FETs include metal-oxide-semiconductor FETs (MOSFETs), Si MOSFETs, silicon carbide (Sic) MOSFETs, gallium nitride (GaN) high electron mobility transistors (HEMTs), and SiC junction-gate FETs (JFETs). Other examples of switches that can be used include diamond, gallium oxide and other wide band gap (WBG) semiconductor-based power switch devices.

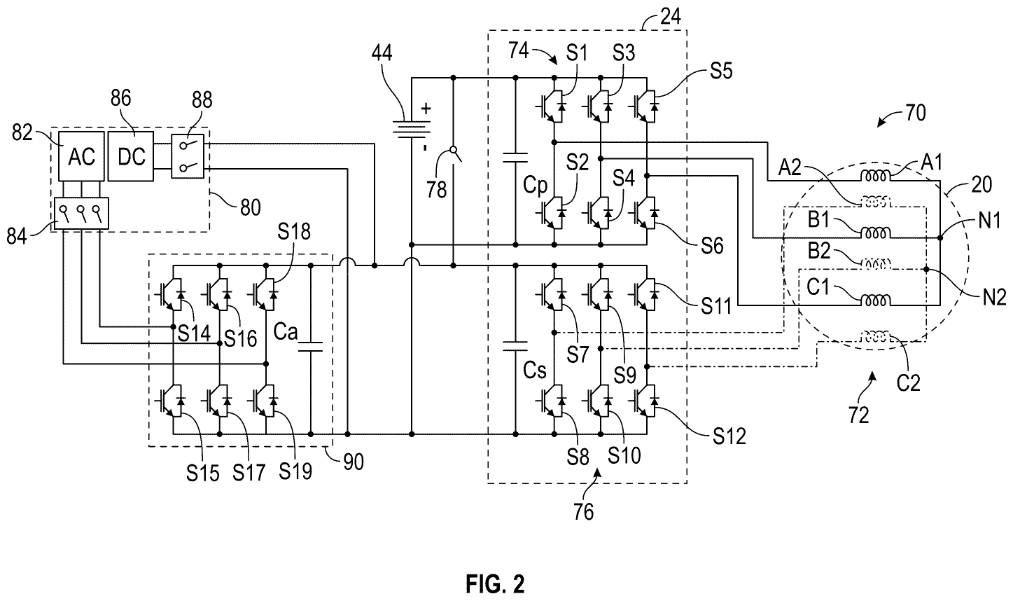

FIG. 2 depicts components of the propulsion system and battery system that form part of the charging system. Although only the motor 20 and inverter module 24 are shown and discussed, it is to be understood that the motor 30 and the inverter 34 may be similarly configured (in addition to or in place of the motor 20 and the inverter module 24).

In an embodiment the electric motor 20 is a dual winding motor, which includes two sets of three-phase (or poly-phase) windings. For example, the motor 20 is a segmented-winding machine having at least two sets of windings. The sets of windings include a primary winding 70 having a first set of phase windings A1, B1, C1, and a secondary winding 72 having a second set of phase windings A2, B2, C2. The primary winding 70 is electrically isolated from the secondary winding 72, and the windings 70 and 72 have respective neutral points N1 and N2.

The inverter module 24 includes a first or primary inverter circuit (inverter) 74 electrically connected to the first winding 70, and a second or secondary inverter 76 electrically connected to the second winding 72. The inverters include sets of switches in half bridge configurations for driving the windings. The primary inverter 74 includes switches S1 and S2 connected to the phase winding A1, switches S3 and S4 connected to the phase winding B1, and switches S5 and S6 connected to the phase winding C1. A capacitor Cp is connected in parallel to the sets of switches in the inverter 76.

The secondary inverter 76 includes switches S7 and S8 connected to the phase winding A2, switches S9 and S10 connected to the phase winding B2, and switches S11 and S12 connected to the phase winding C2. A capacitor Cs is connected in parallel to the sets of switches in the inverter 76.

The capacitors Cp and Cs function to stabilize voltage and limit current fluctuations and ripple. The inverters 74 and 76, in an embodiment, share a common capacitor.

The propulsion system including the motor 20 may be put into a propulsion mode, in which the primary inverter 74 and/or the secondary inverter 76 drive the motor 20. In an exemplary propulsion mode, a switch 78 is closed, and both inverters 74 and 76 drive the motor 20. In another propulsion mode, the switch 78 is open, and the inverters 74 and 76 may be used independently to drive the motor.

The propulsion system may be put into any of various charging modes. When the system is in a charging mode, the motor 20 is in a zero-torque condition and the switch 78 may be opened to disconnect the inverter 76 from the battery pack 44. During charging of the battery pack 44, the inverter 74 and the inverter 76 are used to control a charging current. The windings 70 and 72 function as an isolated transformer for energy transfer. An amount of power provided when charging or discharging may be controlled based on motor speed.

The charging modes include, for example, a mode in which the battery pack 44 is charged by an external power source. The external power source may be a charging station, a portable charger, an electrical grid or a battery system of another vehicle (V2V charging). The charging system is capable of providing a wide variety of charging modalities, including conventional or legacy charging and DC fast charging (DCFC).

The charging modes may include one or more discharge modes in which energy from the battery pack 44 is provided to charge an external energy storage systems. Examples of discharge modes include V2G charging, vehicle-to-trailer charging, V2V charging, V2X charging and others.

The charge port 58 includes or is connected to a charger 80. The charger 80, in an embodiment, is a universal charger that includes capabilities for transferring and controlling AC or DC current during charging and discharging.

For example, as shown in FIG. 2, the charger 80 includes an AC charger 82 connected to a set of switches 84. The AC charger 82 includes components for controlling the magnitude of AC current through the charge port 58. The charger 80 also includes a DC charger 86 and a pair of switches 88.

The set of switches 84 enables bi-directional AC charging. By operating appropriate switches, single-phase, two-phase or three-phase current can be applied via the AC charger 82. An auxiliary converter 90 may be included for controlling AC current, and includes sets of switches for each phase, and a capacitor Ca. A first set of switches S14 and S15 controls a first AC phase, a second set of switches S16 and S17 controls a second AC phase, and a third set of switches S18 and S19 controls a third AC phase. Each half bridge of the auxiliary converter 90 is connected to one of the set of switches 84.

In an embodiment, the propulsion system is used to control energy transfer to and from a vehicle battery system via a control method that is used to apply charging current according to a reference current value. The reference current value, in an embodiment, is a minimum charging current magnitude that can be applied to achieve or maintain a desired charging power. The method provides for charging or discharging at a maximized or desired power, while reducing or minimizing power loss or energy loss.

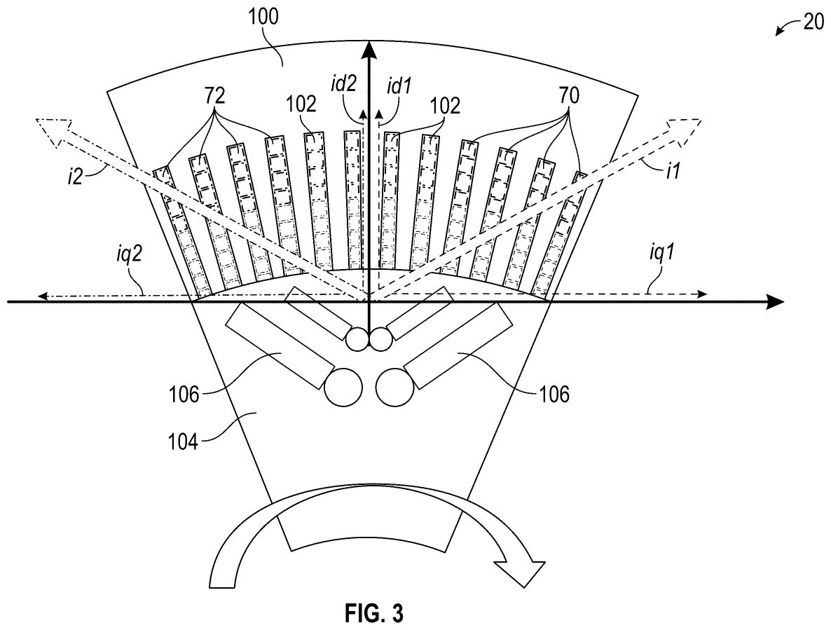

Aspects of the method are described in conjunction with FIG. 2, and also in conjunction with an example of a model of the motor 20 shown in FIG. 3.

FIG. 3 depicts a portion of a stator 100, a segment of the primary winding 70 and a segment of the secondary winding 72. A tertiary winding 102 segment is also shown, which may be included, for example, to reduce unbalancing in the primary winding 70 and redistribute flow of fault currents. FIG. 3 also depicts a portion of a rotor 104 including a set of permanent magnets 106.

FIG. 3 also depicts current vectors associated with the windings 70 and 72. The current vectors include a vector i₂ representing current through the secondary winding 72, and a vector i₁ representing current through the primary winding 70. Each vector has a q-axis component (q-axis current) and a d-axis component (d-axis current). The primary current vector i₂ has a d-axis current i_{d1} and a q-axis current i_{q1}, and the secondary current vector i₂ has a d-axis current i_{d2} and a q-axis current i_{q2}. The current vectors i₂ and i₂ are symmetric about the d-axis. The d-axis currents i_{d1} and id2 are both positive and have the same amplitude. The q-axis currents i_{q1} and iq2 have the same amplitude but opposite sign.

During rotation, when the motor 20 is in a propulsion mode, the voltage and current of the primary winding 70 are in phase with the voltage and current of the secondary winding 72, and the motor 20 converts electrical power to mechanical power. The motor 20 can be put into in a re-generation mode, in which the motor 20 converts mechanical power to electrical power. When the motor 20 is in a charging mode, the voltages of the primary winding 70 and the secondary winding 72 are in phase, and the current of the primary winding 70 is out of phase (e.g., shifted by 180 degrees) with the current of the secondary winding 72. In the charging mode, power flows from one winding to another winding and the motor 20 functions as a transformer.

During power transfer under zero-torque, the motor 20 is in a charging mode and the current vectors i₁ and i₂ rotate at synchronous speed as the rotor 104 rotates. The rotation speed of the rotor 104 can be varied based on power need.

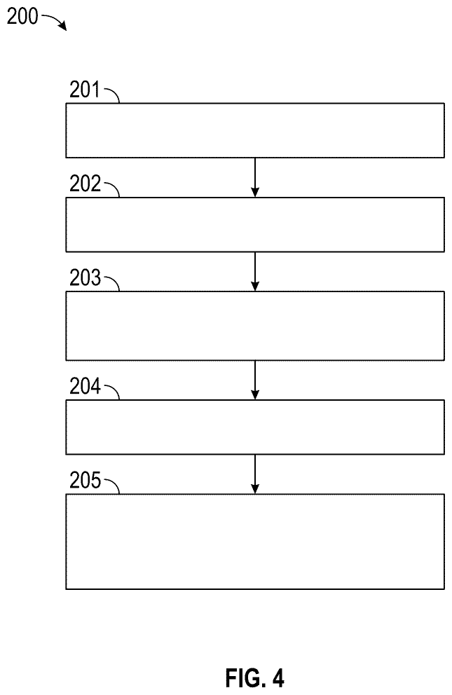

FIG. 4 illustrates embodiments of a method 200 of controlling energy transfer. The energy transfer may be performed to charge a battery system in a vehicle by controlling charging current provided by an external power source, and/or by controlling charging current supplied by the battery system to an external energy storage system.

Aspects of the method 200 may be performed by a processor or combination of processors. For example, if the method is used to supply power to a load from multiple battery systems in a vehicle, one or more controllers in the vehicle may be used. In other examples, such as charging one or more vehicles from a charging station, the method may be performed by a controller in the charging station and/or controller(s) within connected vehicle(s).

It is noted the method 200 is not so limited and may be performed by any suitable processing device or system, or combination of processing devices.

The method 200 includes a number of steps or stages represented by blocks 201-205. The method 200 is not limited to the number or order of steps therein, as some steps represented by blocks 201-205 may be performed in a different order than that described below, or fewer than all of the steps may be performed.

In the following, the method 200 is discussed in conjunction with the motor 20, the propulsion system and the battery system 40 shown in FIGS. 2 and 3 for illustration purposes. The method 200 may be performed similarly in conjunction with the motor 30. In addition, the method 200 may be performed with any suitable system having a multi-winding electric machine and energy storage, and is thus not limited to the systems described herein.

At block 201, the controller 60 (and/or other processing device such as an RESS controller, a battery management system (BMS) controller, etc.) receives a request for power transfer between the battery system 40 and an external energy source or energy storage system.

The request may be a request to provide power to an external energy storage system, such as another vehicle for V2V charging. In other embodiments, the request is for charging the battery system 40 from a charging station or other energy source.

At block 202, the controller 60 receives or determines power transfer or charging parameters, such as desired charging voltage or maximum voltage, desired charging power and motor parameters (e.g., properties of windings such as number of turns in each set of windings 70 and 72).

At block 203, the controller 60 evaluates the power transfer capability of the motor 20 when the motor 20 is in a charging (power transfer) mode. This evaluation is based on the active power expression of the motor 20.

The power transfer capability may be determined by acquiring or calculating a power transfer index. In an embodiment, the power transfer index is an energy E (i.e., amount of energy converted as a function of electrical angle), which is a function of d-axis and q-axis currents.

In an embodiment, the energy E is derived from the following active power (P) equation:

$$P = {ω}_{re} \frac{3}{2} ( {λ}_{d 2} {i}_{q 2} - {λ}_{q 2} {i}_{d 2} ) ,$$

$$or$$

$$P = {ω}_{re} \frac{3}{2} ( ( {L}_{md} {i}_{d 1} + {L}_{d} {i}_{d 2} + {λ}_{pm} ) {i}_{q 2} - ( {L}_{mq} {i}_{q 1} + {L}_{q} {i}_{q 2} ) {i}_{d 2} ) ,$$

where ωᵣₑ is rotational speed of the motor 20. λ_{d2} is the d-axis flux linkage of the secondary winding 72, λ_{q2} is the q-axis flux linkage of the secondary winding 72, and λₚₘ is the flux linkage of the permanent magnets 106. L_{md} is the d-axis mutual inductance between the two windings, L_{mq} is the q-axis mutual inductance between the two windings, L_{d} is the d-axis winding inductance, and L_{q} is the q-axis winding inductance.

E can be derived from the above equation as follows:

$$E = \frac{P}{{ω}_{re}} = \frac{3}{2} ( {λ}_{d 2} {i}_{q 2} - {λ}_{q 2} {i}_{d 2} ) ,$$

$$or$$

$$E = \frac{3}{2} ( ( {L}_{md} {i}_{d 1} + {L}_{d} {i}_{d 2} + {λ}_{pm} ) {i}_{q 2} - ( {L}_{mq} {i}_{q 1} + {L}_{q} {i}_{q 2} ) {i}_{d 2} ) .$$

The energy E can be calibrated, for example, by operating the motor 20 experimentally and/or via simulation. A model of the motor 20, such as a d-q model (aspects of which are shown in FIG. 3), is used to simulate operation and determine or calibrate optimal values of d-axis current and q-axis current for various levels of energy transfer. The optimal values can be stored as a look-table or other data structure for use in calibrating an optimal charging current to achieve a desired power.

The index is used to determine an optimal combination of d-axis and q-axis currents. In an embodiment, the optimal combination refers to the d-axis and q-axis currents that provide a desired power to be transferred with minimal current usage.

At block 204, the motor 20 is put into a charging mode by electrically connecting the charger 80 to the external source or storage system. For DC power transfer, the pair of switches 88 is closed, and all of the switches of the set of switches 84 are open. For AC power transfer, the pair of switches 88 is open, and at least one switch of the set of switches 84 is closed.

At block 205, energy transfer (charging or discharging) is initiated by receiving a charging current (if the energy transfer is used to charge the battery pack 44) or generate a charging current (if the energy transfer is used to charge an external energy storage system).

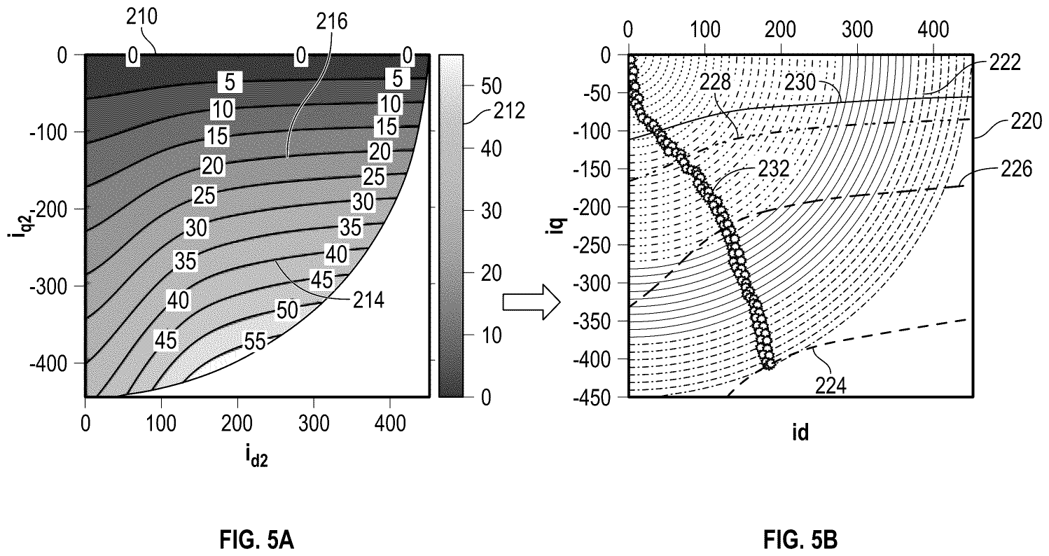

Energy transfer is controlled by adjusting or controlling the magnitude of the charging current based on a maximum power per ampere (MPPA) control methodology to apply a charging current based on the minimum values. For example, the controller 60 periodically receives voltage and current measurements, determines actual d-axis and q-axis currents, and compares them to a limit that includes minimum d-axis and q-axis currents needed to produce a desired power level. An example of MPPA control is shown in FIGS. 5A and 5B discussed further herein.

Control of the charging current may be performed in real time. Comparison to the set points and control of the charging current may be performed in real time, for example, by continuously (e.g., at each sample time generating current sensor and other sensor outputs).

For example, to control AC charging (receiving AC power from a grid or other external source), AC current is received via the charger 82 and the charging current is adjusted via the charger 82 according to the set points.

The charging current flows through the auxiliary converter 90, which may be controlled to adjust parameters such as phase and voltage. The charging current flows through the inverter 76 to the phase windings A2, B2 and/or C2, and the windings 70 and 72 function as an isolated transformer. The inverter 74 is used as a synchronous active pulse width modulation (PWM) rectifier to convert AC to DC to charge the battery pack, and control the power. Switches in the auxiliary converter 90 may also be used to perform power factor correction (PFC), which reduces harmonic distortion in the AC supplied to the inverter module 24 (i.e., shapes the line current to create a current waveform close to a fundamental sine wave and aligns the phase with the voltage from the external source).

To control power transfer from the battery pack 44 to an external system (i.e., discharging), DC current from the battery pack 44 is converted to AC current by the inverter 74, and the AC current is fed to the phase windings A1, B1 and/or C1. The windings 70 and 72 again function as a transformer (optionally stepping up or stepping down voltage), and AC current flows through the inverter 76 and is output to supply charge to the external system.

To control DC charging (e.g., DCFC charging) or discharging (e.g., V2V) the switches 84 are all open, and the pair of switches 88 are closed. If the voltage of the battery pack 44 is the same as the received voltage, the switch 78 is closed, and the received DC power is fed directly to the battery pack 44.

If the voltages are different, the switch 78 is open, and the two sets of windings function as an isolated transformer and both inverters 74 and 76 are used as a dual active bridge DC-DC converter to control the power in either direction. For example, voltage may be boosted by appropriate control of the switches in the inverters 74 and 76.

FIGS. 5A and 5B depict aspects of an example of the method 200, and illustrate how optimal d-axis and q-axis current is determined. FIG. 5A is a contour plot 210 of energy E as a function of d-axis current (i_{d2}) in the winding 72 (e.g., through one or more of phases A2, B2 and C2), and q-axis current (i_{q2}) in the winding 72, as determined via modeling and/or calibration. The currents are expressed in Amps (A) and the energy E is expressed in kilowatt-seconds per radian (kWs/rad).

The contours reflect values of E for various combinations of i_{d2} and i_{q2} magnitudes and are color-coded as shown by a legend 212. For example, a contour 214 represents combinations of i_{d2} and iq2 values corresponding to an energy of 40 kW/sec, and a contour 216 represents combinations of i_{d2} and i_{q2} values corresponding to an energy of 20 kW/sec.

FIG. 5B depicts an example of results of the d- and q-axis current estimation, shown in a contour plot 220. The contour plot 220 represents power P as a function of d-axis current (i_{d}) and q-axis current (i_{q2}). Lines 222 represent different current amplitudes.

The plot 220 also shows various power levels for different motor speeds. The plot 220 may be generated by converting the energy E to power P based on motor speed (i.e., P=E*ωᵣₑ). Such power limits may be rated limits or limits determined via modelling or experimentation. For example, curve 224 represents the power P as a function of i_{d} and i_{q2}, for a motor speed (i.e., mechanical speed of a rotor) of about 1000 RPM (revolutions-per-minute), curve 226 represents the power P for a motor speed of about 2000 RPM, curve 228 represents the power P for a motor speed of about 4000 RPM, and curve 230 represents the power P for a motor speed of about 6000 RPM.

A curve 232 represents a maximum power per ampere (MPPA) determined as part of a control method as discussed above. The relationship shown by the curve 232 is used by the controller in this example to determine the magnitude of an applied charging current.

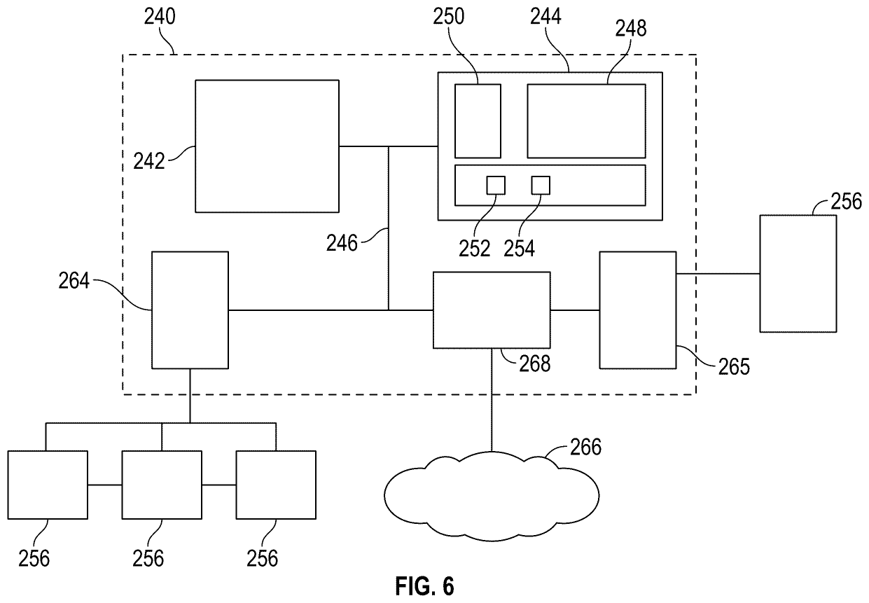

FIG. 6 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 252 may be included for performing functions related to acquiring signals and data, and a module 254 may be included to perform functions related to control of energy transfer as discussed herein. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this invention belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An energy transfer system of a vehicle, comprising:
a multi-winding motor including a first set of windings and a second set of windings, the multi-winding motor connected to a battery system;
a first inverter connected to the first set of windings;
a second inverter connected to the second set of windings; and
a controller configured to receive a request for transfer of energy, put the multi-winding motor into a charging mode, and control the first inverter and the second inverter to control a charging current through the multi-winding motor at a desired power when the multi-winding motor is in a zero-torque condition, wherein the controller is configured to control the charging current through the first inverter and second inverter so that a first current vector associated with the first set of windings and a second vector associated with the second set of windings are symmetric about a d-axis and the multi-winding motor functions as a transformer, the control of the first inverter and the second inverter providing for power transfer between the first set of windings and the second set of windings.

2. The system of claim 1, wherein the controller is configured to control the charging current based on a reference charging current value derived from a calibration of an optimal value of a d-axis current and an optimal value of a q-axis current, the optimal values determined based on a power transfer capability of the multi-winding motor.

3. The system of claim 2, wherein the reference charging current value is a minimum magnitude of the charging current that can be applied to achieve a desired charging power.

4. The system of claim 2, wherein the power transfer capability is estimated based on an energy relation indicative of an energy E as a function of the d-axis current and the q-axis current.

5. The system of claim 4, wherein the power transfer capability is used to determine a maximum power per ampere (MPPA) for a given motor speed.

6. The system of claim 5, wherein the MPPA prescribes a minimum charging current for a given motor speed, the minimum charging current determined based on the optimal value of the d-axis current and the optimal value of the q-axis current.

7. The system of claim 1, further comprising a switch configured to selectively connect the first inverter to the battery system, the switch configured to be closed when the vehicle is in a propulsion mode.

8. The system of claim 7, wherein the charging current is an AC current, the switch is configured to be open to put the multi-winding motor into the charging mode, and the controlling of the first inverter and the second inverter includes operating the first set of windings and the second set of windings as an isolated transformer to transfer power between the first set of windings and the second set of windings.

9. A method of transferring energy to or from a battery system of a vehicle, comprising:
receiving a request for transfer of energy at a controller connected to a charging system of the vehicle, the charging system including a multi-winding motor including a first set of windings and a second set of windings, a first inverter connected to the first set of windings, and a second inverter connected to the second set of windings, wherein the multi-winding motor is connected to the battery system;
putting the multi-winding motor into a charging mode; and
controlling the first inverter and the second inverter to control a charging current through the multi-winding motor at a desired power when the multi-winding motor is in a zero-torque condition, wherein the charging current is controlled through the first inverter and second inverter so that a first current vector associated with the first set of windings and a second vector associated with the second set of windings are symmetric about a d-axis and the multi-winding motor functions as a transformer, the controlling of the first inverter and the second inverter providing for power transfer between the first set of windings and the second set of windings.

10. The method of claim 9, wherein the control of the charging current is based on a reference charging current value derived from a calibration of an optimal value of a d-axis current and an optimal value of a q-axis current, the optimal values determined based on a power transfer capability of the multi-winding motor.

11. The method of claim 10, wherein the reference charging current value is a minimum magnitude of the charging current that can be applied to achieve a desired charging power.

12. The method of claim 10, wherein the power transfer capability is estimated based on an energy relation indicative of an energy E as a function of the d-axis current and the q-axis current.

13. The method of claim 12, wherein the energy relation is derived by at least one of simulation and experimentation.

14. The method of claim 12, wherein the power transfer capability is used to determine a maximum power per ampere (MPPA) for a given motor speed, the MPPA prescribing a minimum charging current for a given motor speed, the minimum charging current determined based on the optimal value of the d-axis current and the optimal value of a q-axis current.

15. The method of claim 9, wherein the charging system includes a switch configured to selectively connect the first inverter to the battery system, the switch configured to be closed when the vehicle is in a propulsion mode.

16. The method of claim 15, wherein the charging current is an AC current, and putting the multi-winding motor into the charging mode includes opening the switch, and controlling the first inverter and the second inverter includes operating the first set of windings and the second set of windings as an isolated transformer to transfer power therebetween.

17. A vehicle system comprising:
a memory having computer readable instructions; and
a processing device for executing the computer readable instructions, the computer readable instructions controlling the processing device to perform a method including:
receiving a request for transfer of energy at a controller connected to a charging system of the vehicle, the charging system including a multi-winding motor including a first set of windings and a second set of windings, a first inverter connected to the first set of windings, and a second inverter connected to the second set of windings, the multi-winding motor connected to the battery system;
putting the multi-winding motor into a charging mode; and
controlling the first inverter and the second inverter to control a charging current through the multi-winding motor at a desired power when the multi-winding motor is in a zero-torque condition, wherein the charging current is controlled through the first inverter and second inverter so that a first current vector associated with the first set of windings and a second vector associated with the second set of windings are symmetric about a d-axis and the multi-winding motor functions as a transformer, the controlling of the first inverter and the second inverter providing for power transfer between the first set of windings and the second set of windings.

18. The vehicle system of claim 17, wherein the control of the charging current is based on a reference charging current value derived from a calibration of an optimal value of a d-axis current and an optimal value of a q-axis current, the optimal values determined based on a power transfer capability of the multi-winding motor, wherein the reference charging current value is a minimum magnitude of the charging current that can be applied to achieve a desired charging power.

19. The vehicle system of claim 18, wherein the power transfer capability is estimated based on an energy relation indicative of an energy E as a function of the d-axis current and q-axis current.

20. The vehicle system of claim 19, wherein the power transfer capability is used to determine a maximum power per ampere (MPPA) for a given motor speed, the MPPA prescribing a minimum charging current for a given motor speed, the minimum charging current determined based on the optimal value of the d-axis current and the optimal value of the q-axis current.
